(19) United States
(12) Patent Application Publication
(10) Pub. No.: US 2014/0263080 A1
(43) Pub. Date: Sep. 18, 2014

(54) IN-LINE TAILINGS TREATMENT PROCESS

(71) Applicant: ECOLAB USA INC., Naperville, IL (US)

(72) Inventor: Carl N. Urbani, Forrestfield (AU)

(21) Appl. No.: 13/798,482

(22) Filed: Mar. 13, 2013

(51) Int. Cl. C02F 1/52

(52) U.S. Cl. CPC C02F 1/5281
USPC 210/713

(57) ABSTRACT

The invention is directed towards methods and compositions for improving the processing of mineral tailings. The method involves diverting a side stream from the main line of a tailings process flow. Into this side stream an additive such as a neat polymer without dilution is added and mixed and is then returned into the main line. By doing this only a portion of the overall tailings flow needs to undergo mixing yet the additive effectively treats the tailings. Even better the process avoids the need to add water to first invert and dilute the polymer additive. As a result tailings can be processed without incurring unnecessary mixing costs and unnecessary water addition.

### CROSS-REFERENCE TO RELATED APPLICATIONS

Not Applicable

### STATEMENT REGARDING FEDERALLY SPONSORED RESEARCH OR DEVELOPMENT

Not Applicable.

### BACKGROUND OF THE INVENTION

The present invention relates generally to one or more methods, compositions of matter, and or apparatuses useful in treating mineral slurries. Mineral slurries such as tailings and other waste material have become a technical, environmental and public policy issue. Mineral extraction and refining processes including but not limited to those for coal, oil, iron, aluminum, copper, metals, precious metals, zinc, lead, mineral sands and rare earth metals, often produce a huge quantity of waste material known as tailings. Tailings are often in the form of aggregate slurries which can be in aqueous suspension with dispersed particulate solids, for instance sand, clay, shale and other minerals. It has been and still is a sizable issue for industry to treat these tailings and accomplish liquid solid separation at the processes end to separate liquid from the solid. This drastically reduces the mass of the tailings and makes the disposal and/or recycling of tailings, easier, safer, and more environmentally friendly.

A number of approaches have been developed to facilitate the handling and disposal of tailings. U.S. Pat. Nos. 6,544,425 and 5,449,464, and US Published Patent Applications 2011/0135797, 2010/0187181, 2008/0190860, 2011/0131873, 2011/0000854, and 2009/0020458 describe a number of previously contemplated approaches. As described in U.S. Pat. Nos. 6,485,651, 5,788,867, and 7,901,583, a particularly effective approach involves the addition of synthetic or natural polymers such as coagulants and flocculants to separate the solids from the liquid. In addition, as described in US Published Patent Application 2012/0138542, a particularly effective method for introducing chemicals into slurry is to do so using an in-line introduction method. An ideal method of processing tailings however would make better use of chemical additives by optimal in-line addition of the additives in a highly efficient manner.

As a result there is ongoing need and clear utility in a novel improved method and/or composition and/or apparatus for inline treatment of a tailings process stream. The art described in this section is not intended to constitute an admission that any patent, publication or other information referred to herein is “Prior Art” with respect to this invention, unless specifically designated as such. In addition, this section should not be construed to mean that a search has been made or that no other pertinent information as defined in 37 CFR §1.56(a) exists.

### BRIEF SUMMARY OF THE INVENTION

At least one embodiment of the invention is directed towards a method for improving inline mineral slurries treatment. The method comprises successively: providing an in-line flow of slurries in a main line stream; diverting a portion of the flow from the main line stream into a side stream flow; introducing at least one additive into the side stream flow through at least one injection point to cause dispersion of the additive and to start consolidation of the solids within the slurries to produce treated slurries; passing the side stream flow into a mixing device; reintroducing the side stream flow into the main line; and transferring at least a portion of the main flow line into a deposit area.

The mineral slurry may comprise mineral tailings slurry derived from one or more of gold ore, platinum ore, nickel ore, coal ore, copper ore, iron ore, metal ore, ore-body from a diamond mine, or phosphate or gold tailings, red mud from the Bayer alumina process, tailings resulting from oil sands extraction, tailings from lead ore, zinc ore or mineral sands processing and Mature Fine Tailings. The mixing device may be a static mixer. The amount of water introduced to the main line stream from the side stream flow may be no greater than the amount of water diverted into the side stream flow plus the amount of water present in a neat form of the additive. The additive may be an oil in water emulsion, water in oil emulsion or solid polymer which is introduced in neat form. The additive may be introduced into the side stream flow by dosing the side stream slurry flow with an effective amount of additive, allowing the mixer to induce sufficient shear to and for a sufficient time to invert and release the polymer into the side stream flow. The additive may be a quick inverting polymer which is introduced in neat form. The additive may be introduced into the side stream flow by dosing the side stream flow slurry with an effective amount of least one water-in-tail emulsion comprising at least one polymer, at least one hydrophilic surfactant and at least one high terpene content natural oil, said surfactant being present in the emulsion at a concentration of from about 1 to about 10 percent, by weight; allowing the mixer to induce sufficient shear to and for a sufficient time for the at least one emulsion to invert and release the at least one polymer into the side stream flow. The net flow rate of the main line flow may be the same as the net flow rate of the side stream flow but the rate of the side stream flow upstream and downstream from the mixing device differs from the net flow rate of the main line flow. The degree of respective consolidation and water release of the treated slurry may be greater than if a greater dosage of the additive were added directly into the main line flow. Between 0.1-50% of the slurry in the main line flow may be diverted into the side stream flow. The method may further comprise the step of effecting a solid-liquid separation after the side stream flow has been reintroduced to the main line flow.

### BRIEF DESCRIPTION OF THE DRAWINGS

A detailed description of the invention is hereafter described with specific reference being made to the drawings in which:

FIG. 1 is an illustration of a process stream utilizing the invention.

For the purposes of this disclosure, like reference numerals in the figures shall refer to like features unless otherwise indicated. The drawings are only an exemplification of the principles of the invention and are not intended to limit the invention to the particular embodiments illustrated.

### DETAILED DESCRIPTION OF THE INVENTION

The following definitions are provided to determine how terms used in this application, and in particular how the claims, are to be construed. The organization of the definitions is for convenience only and is not intended to limit any of the definitions to any particular category.

“Consolidate” means a process in Which the solid particles of a slurry, aggregate together to form high solids density regions which conversely results in low solids density regions within the slurry, it can result in separation of the solid materials from the liquid phase of the slurry, types of consolidation include but are not limited to coagulation and/or flocculation.

“In-Line” means introduced into slurry flowing through a process stream.

“Slurry” means a mixture of solid particles suspended within a liquid carrier.

“Neat” means a composition of matter in the form in which it is typically stored or transported and which is different than the form in which it is typically applied to effect a chemical result, in the case of compositions which operate in aqueous environments such as polymers, “Neat” can mean in the form of an a oil-in water emulsion which is too concentrated and contains too little water to invert into a water-in oil emulsion. Alternatively it may mean a solid polymer.

“Tailings” means masses of waste material resulting from a mineral extraction or refining operation, tailings can be solid and/or slurry.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

Referring now to FIG. 1 there is shown at least one embodiment of the invention. A process stream comprising a flow of slurry is passing through a main line flow path (1). At a diversion point (2) in the main line flow path a portion of the flowing slurry comprising between 0.1-50% of the overall flow is diverted into a side stream flow path (3). Within the side stream flow path (3) at least one processing additive is added to the slurry at an addition point (4). The slurry and the processing additive are suitably mixed together. This mixing can optionally be accomplished by passing the two into a mixing apparatus (5) including but not limited to a static mixer. At a junction point (6) the mixed side stream flow is then rejoined to the main line flow path (1). The main line flow path (1) may then undergo further processing or be discharged into a waste pond or receptacle (7).

In at least one embodiment one or more side streams are diverted from the main line at one or more locations along the main line. In at least one embodiment one or more side streams are re-introduced into the main line at one or more junction points along the main line. In at least one embodiment more than one side stream is diverted from the main line and at least one portion of the treatment the side streams undergoes (one or more of additive type, additive dosage, additive concentration, mixing speed, mixing time, mixer type, and flow rate) differs or is the same.

In at least one embodiment the flow rates through a side stream and through the main line are the same or different. In at least one embodiment the net flow rate of the side stream and the main line are the same such that the flow rate before and/or after the mixing step in the side stream is faster than that in the main line to compensate for the side stream residing in the mixer for a period of time. In at least one embodiment the flow rate in the main line or the side stream may be between 0.01 m³/h and 10,000 m³/h.

In at least one embodiment the processing additive comprises a composition of matter including but not limited to one or more of those described in U.S. Pat. No. 6,485,651. As described in U.S. Pat. Nos. 3,734,873 and 5,679,740, many processing additives are stored and transported in the form of an oil-in water emulsion, in this form however the active portions of the composition cannot effectively interact with the contents of an aqueous medium. As a result when they are to affect the slurry the composition needs to have been inverted into a water-in oil type emulsion.

In prior art methods, when inverted compositions such as polymers are added to a slurry stream they first pass through an inversion rig within which the additive undergoes mixing for a time with added water so neat composition inverts into a water-in oil emulsion. Only after being inverted is the additive then added to the slurry. In contrast in at least one embodiment neat and/or non-inverted additive is added directly into the side stream without previously undergoing inversion.

This method is the exact opposite of what is taught by the prior art which teaches that not only must all of the stream be mixed, but that some of the stream must be repeatedly mixed to properly effect the slurry with the additive. For example, in US Published Patent Application 2012/0138542, a slurry stream undergoes mixing and then a slip stream of the already mixed stream is re-fed into the to-be mixed stream. In contrast to this, in the inventive method at least a portion of the stream never passes through a mixer yet as the Examples below demonstrate, superior results are observed. In at least one embodiment the addition of the additive is accomplished without the addition of any water other than that present in the neat form of the polymer. This is quite different than prior art methods which typically require the addition of water in excess of that in the neat formulation to invert the additive. As a result the end slurry after treatment contains far less water and is less voluminous, less costly and is easier to dispose of.

In at least one embodiment the processing additive comprises a polymer such as any type of water-soluble or water swell-able polymer, including natural, semi-natural and synthetic polymers. The polymers may include a wide variety of organic polymers which need to be selected depending for example of the nature of the tailings, their solids concentration, and other parameters well-known by the skilled man of the art. The natural polymers may be for instance polysaccharides such as dextran, starch or guar gum. The semi-natural polymer may be carboxymethyl cellulose. Synthetic polymers may be a coagulant and/or a flocculant. Particularly suitable water soluble or water swellable polymers are based on acrylamide. They can be cationic, anionic, non-ionic or amphoteric polymer.

The polymer can be made by the polymerisation of a) one or more non-ionic monomer selected from the group comprising (meth)acrylamide, (meth)acrylic, vinyl, allyl or maleic backbone and having a polar non-ionic side group: mention can be made in particular, and without this being limitation, of acrylamide, methacrylamide, N-vinyl pyrrolidone, N-vinyl formamide, N,N dimethylacrylamide, acetamide, N-vinylpyridine, N-vinylimidazole, isopropyl acrylamide and polyethelene glycol methacrylate and/or b) one or more anionic monomer(s) comprising (meth)acrylic, vinyl, allyl or maleic backbone, mention can be made in particular, and without this being limitation, of monomers having a carboxylic function (e.g.: acrylic acid, methacrylic acid and salts thereof), or having a sulphonic acid function (e.g.: 2-acrylamido-2-methylpropane sulphonic acid (ATBS) and salts thereof) and/or c) one or more cationic monomer(s) comprising (meth)acrylamide, (meth)acrylic, vinyl, allyl or maleic backbone and having an amine or quaternary ammonium function, mention can be made in particular, and without this being limitation, of quaternized or salified dimethylaminoethyl acrylate (ADAME) and/or dimethylaminoethyl methacrylate (MADAME); dimethyldiallylammonium chloride (DADMAC), acrylamido propyltrimethyl ammonium chloride (APTAC) and/or methacrylamido propyltrimethyl ammonium chloride (MAPTAC).

The polymer may contain one or more monomers having a hydrophobic character. Hydrophobic monomers are preferably selected from the group including (meth)acrylic acid esters with an alkyl, arylalkyl and/or ethoxylated chain, derivates of (met)acrylamide with an alkyl, arylalkyl or dialkyl chain, cationic allyl derivates, anionic or cationic hydrophobic (meth)acryloyl derivates, or anionic and/or cationic monomers derivates of (meth)acrylamide bearing a hydrophobic chain. Anionic polymers may be formed from monomers selected from ethylenically unsaturated carboxylic acid and sulfonic acid monomers, preferably selected from (meth)acrylic acid and/or 2-Acrylamido-2-methylpropane sulfonic acid, and their salts, combined with non-tonic co-monomers, preferably selected from (meth)acrylamide, N-vinyl pyrrolidone.

The polymer may be linear, branched or crosslinked. Branching or crosslinking agents are selected from the group comprising methylene bisacrylamide (MBA), ethylene glycol diacrylate, polyethylene glycol dimethacrylate, diacrylamide, cyanomethylacrylate, vinyloxyethylacrylate or methacrylate, triallylamine, formaldehyde, glyoxal, compounds of the glycidylether type such as ethyleneglycol diglycidylether, or epoxy.

The dosage of the polymer added in the in-line flow may be between 50 and 5,000 g per ton of dry solids of mineral slurries, preferably between 250 and 2,000 g/t, and more preferably between 500 and 1,500 g/t, depending on the nature and the composition of the tailings to be treated.

The process of the invention is suitable for treating aqueous mineral slurries of particulate solids. Mineral slurries result from the processing of minerals which includes ore beneficiation and the extraction of minerals. Minerals broadly include ores, natural substances, inorganics, mixtures of inorganic substances and organic derivatives such as coal.

The slurry may contain tailings of suspended particulate solids. Typical slurries include but are not limited to aqueous tailings or mineral slurries obtained from a gold ore, platinum ore, nickel ore, coal ore, copper ore, or an ore-body from a diamond mine, or phosphate or gold tailings, red mud from the Bayer alumina process, tailings resulting from oil sands extraction, and Mature Fine Tailings (MFT) which are specific because of the large proportion of fine solid particles, less than 44 microns. MFT are difficult to dewater and to solidify.

Without being limited by a particular theory or design of the invention or of the scope afforded in construing the claims, it is believed that the method is able to take advantage of the kinetic energy inherent in the process stream to effectively disperse and invert the additives and thereby consolidate the solids contained in the tailings slurry without directly mixing all of the flowing slurry with the additives. This drastically reduces the capital costs associated with processing tailings slurry.

### EXAMPLES

The foregoing may be better understood by reference to the following examples, which are presented for purposes of illustration and are not intended to limit the scope of the invention.

Laboratory testing was conducted on 4 samples of coal tailings slurry.

### Example 1

A side stream was simulated by taking a sample of 100 nil of coal tailings slurry comprising 16% solids which was stirred using a cage stirrer at 800 rpm. An acrylamide/acrylate latex polymer was added to the mixture and the resulting slurry was stirred for 5 minutes. A 0.2 ml aliquot of this mixed slurry was added to 200 ml of untreated coal tailings slurry in a 400 ml cup which simulated return of the side stream to the main line. Further passage of the main line was simulated by pouring the cups contents into another cup 5 times. At this point all the solids in the cup had consolidated and settled leaving clear water visible in the cup. The dose of the polymer was equivalent to 280 g/T. In contrast when, the same polymer dose was directly added to a separate slurry sample in another 200 ml cup and similarly repeatedly poured, no consolidation or water release was Observed.

### Example 2

A side stream was simulated by taking a sample of 100 ml of coal tailings slurry comprising 22.5% solids which was stirred using a cage stirrer at 800 rpm. An acrylamide/acrylate latex polymer was added to the mixture and the resulting slurry was stirred for 5 minutes. A 0.5 ml aliquot of this mixed slurry was added to 200 ml of untreated coal tailings slurry in a 400 ml cup which simulated return of the side stream to the main line. Further passage of the main line was simulated by pouring the cups contents into another cup 7 times. A second 0.5 ml aliquot was added to the cup and re-poured 4 more times. At this point the solids in the cup had consolidated and settled leaving clear water visible in the cup. The overall dose of the polymer was equivalent to 660 g/T. In contrast when this same dosage of polymer was directly added to a separate slurry sample in another 400 ml cup and similarly repeatedly poured, no consolidation or water release was observed.

### Example 3

A side stream was simulated by taking a sample of 100 ml of coal tailings slurry comprising 29% solids which was stirred using a cage stirrer at 800 rpm. An acrylamide/acrylate latex polymer was added to the mixture and the resulting slurry was stirred for 5 minutes. A 1.0 ml aliquot of this mixed slurry was added to 100 ml of untreated coal tailings slurry in a 400 ml cup which simulated return of the side stream to the main line. Further passage of the main line was simulated by pouring the cups contents into another cup 20 times. A second 0.5 ml aliquot was added to the cup and re-poured 30 more times. At this point the solids in the cup had consolidated and settled leaving clear water visible in the cup. The dose of the polymer was equivalent to 1530 g/T. In contrast when the polymer at this dosage was directly added to a separate sample in another 400 ml cup and similarly repeatedly poured, no consolidation or water release was observed.

### Example 4

A side stream was simulated by taking a sample of 100 ml of coal tailings slurry comprising 16% solids which was stirred using a cage stirrer at 800 rpm. An acrylamide/acrylate latex polymer (which was different from the polymer used in Example 1) was added to the mixture and the resulting slurry was stirred for 5 minutes. A 0.3 ml aliquot of this mixed slurry was added to 200 ml of untreated coal tailings slurry in a 400 ml cup which simulated return of the side stream to the main line. Further passage of the main line was simulated by pouring the cups contents into another cup 20 times. A second 0.2 ml aliquot was added to the cup and re-poured 20 more times. At this point the solids in the cup had consolidated and settled leaving clear water visible in the cup. The dose of the polymer was equivalent to 470 g/T. In contrast when the same polymer at this dosage was directly added to a separate slurry sample in another 200 ml cup and similarly repeatedly poured, no consolidation or water release was observed.

These examples demonstrate that reintroducing a mixed side stream into a main line causes a different effect than directly introducing that same product into the main line and mixing.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and/or incorporated herein. In addition the invention encompasses any possible combination that also specifically excludes any one or more of the various embodiments described herein and/or incorporated herein.

The above disclosure is intended to be illustrative and not exhaustive. This description will suggest many variations and alternatives to one of ordinary skill in this art. The compositions and methods disclosed herein may comprise, consist of or consist essentially of the listed components, or steps. As used herein the term “comprising” means “including, but not limited to”. As used herein the term “consisting essentially of” refers to a composition or method that includes the disclosed components or steps, and any other components or steps that do not materially affect the novel and basic characteristics of the compositions or methods. For example, compositions that consist essentially of listed ingredients do not contain additional ingredients that would affect the properties of those compositions. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

All numeric values are herein assumed to be modified by the term “about,” whether or not explicitly indicated. The term “about” generally refers to a range of numbers that one of skill in the art would consider equivalent to the recited value (i, having the same function or result). In many instances, the term “about” may include numbers that are rounded to the nearest significant FIGURE. Weight percent, percent by weight, ° A by weight, wt %, and the like are synonyms that refer to the concentration of a substance as the weight of that substance divided by the weight of the composition and multiplied by 100. Percentages and ratios are by weight unless otherwise so stated.

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise. All chemical structures provided in this application contemplate and include every possible stereo isomers, conformational isomers, rotational isomers, and chiral alternative of the specific illustrated structure.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for improving inline mineral slurries treatment comprising successively: providing an in-line flow of slurries in a main line stream; diverting a portion of the flow from the main line stream into a side stream flow; introducing at least one additive into the side stream flow through at least one injection point to cause dispersion of the additive and to start consolidation of the solids within the slurries to produce treated slurries; passing the side stream flow into a mixing device; reintroducing the side stream flow into the main line; and transferring at least a portion of the main flow line into a deposit area.

2. The method of claim 1 in which the mineral slurry comprises mineral tailings slurry derived from one or more of gold ore, platinum ore, nickel ore, coal ore, copper ore, iron ore, metal ore, ore-body from a diamond mine, or phosphate or gold tailings, red mud from the Bayer alumina process, tailings resulting from oil sands extraction, tailings resulting from zinc ore, lead ore or mineral sands processing and Mature Fine Tailings.

3. The method of claim 1 in which the mixing device is a static mixer.

4. The method of claim 1 in which the amount of water introduced to the main line stream from the side stream flow is no greater than the amount of water diverted into the side stream flow plus the amount of water present in a neat form of the additive.

5. The method of claim 1 in which the additive is an oil in water emulsion, water in oil emulsion or solid polymer which is introduced in neat form.

6. The method of claim 5 in which the additive is introduced into the side stream flow by dosing the side stream slurry flow with an effective amount of additive, allowing the mixer to induce sufficient shear to and for a sufficient time to invert and release the polymer into the side stream flow.

7. The method of claim 1 in which the additive is a quick inverting polymer which is introduced in neat form.

8. The method of claim 7 in which the additive is introduced into the side stream flow by dosing the side stream flow slurry with an effective amount of least one water-in-oil emulsion comprising at least one polymer, at least one hydrophilic surfactant and at least one high terpene content natural oil, said surfactant being present in the emulsion at a concentration of from about 1 to about 10 percent, by weight; allowing the mixer to induce sufficient shear to and for a sufficient time for the at least one emulsion to invert and release the at least one polymer into the side stream flow.

9. The method of claim 1 in which the net flow rate of the main line flow is the same as the net flow rate of the side stream flow but the rate of the side stream flow upstream and downstream from the mixing device differs from the net flow rate of the main line flow.

10. The method of claim 1 in which the degree of respective consolidation and water release of the treated slurry is greater than if a greater dosage of the additive were added directly into the main line flow.

11. The method of claim 1 in which between 0.1-50% of the slurry in the main line flow is diverted into the side stream flow.

12. The method of claim 1 further comprising the step of effecting a solid-liquid separation after the side stream flow has been reintroduced to the main line flow.
